(19) United States
(12) Patent Application Publication
(10) Pub. No.: US 2026/0140780 A1
(43) Pub. Date: May 21, 2026

(54) QOS-BASED LOAD BALANCING

(71) Applicant: SAP SE, Walldorf (DE)

(72) Inventor: Hui LI, Shanghai (CN)

(21) Appl. No.: 18/950,424

(22) Filed: Nov. 18, 2024

(51) Int. Cl. G06F 9/50

(52) U.S. Cl. CPC G06F 9/5038; G06F 9/5044

(57) ABSTRACT

Systems and methods include receipt of a first request to a first service from a first tenant associated with a first quality-of-service (QoS) level, receipt of a second request to the first service from a second tenant associated with a second QoS level, retrieval of a first performance score for a first execution environment, retrieval of a second performance score for a second execution environment, association of the first request with the first execution environment based on a relationship between the first QoS level and the first performance score, association of the second request with the second execution environment based on a relationship between the second QoS level and the second performance score, distribution of the first request to the first execution environment, and distribution of the second request to the second execution environment.

### BACKGROUND

Multi-tenancy is a software architecture pattern which facilitates the sharing of computing resources (e.g., processor cycles, memory) among disparate groups of users. For example, a single multi-tenant application may serve requests received from several independent tenants (e.g., customers) each consisting of multiple end users. Such an application may use a much smaller computing resource footprint than would be required to provision one application per tenant.

Multi-tenant applications use various hardware and/or software-driven schemes to allow the sharing of computing resources between tenants while maintaining tenant-specific data isolation. Multi-tenant applications can be cloud-based (e.g., a Software-as-a-Service (SaaS) application) in order to take advantage of the resource elasticity, redundancy, economies of scale and other benefits provided by cloud platforms.

Different tenants sign different SLAs (Service Level Agreements) with application providers. The different SLAs may guarantee different levels of QoS (Quality-of-Service) for the different tenants. For example, a tenant which has been guaranteed a higher level of QoS should receive better service from the application than a tenant which has been guaranteed a lower level of QoS. QoS may be measured and guaranteed in terms of throughput, availability, response time lag, etc.

Since all tenants of a multi-tenant application share computing resources, it can be difficult to provide the tenants with different levels of QoS. Systems are desired to efficiently provide different QoS levels to the different tenants of a multi-tenant application.

### BRIEF DESCRIPTION OF THE DRAWINGS

FIG. 1 illustrates a multi-tenant system providing QoS-specific request distribution according to some embodiments.

FIG. 2 is a flow diagram of a process to provide QoS-specific request distribution according to some embodiments.

FIG. 3 is a tabular representation of QoS levels associated with received requests according to some embodiments.

FIG. 4 is a tabular description of performance metrics according to some embodiments.

FIG. 5 is a tabular representation of performance scores according to some embodiments.

FIG. 6 is a flow diagram of a process to determine servers to which requests are distributed according to some embodiments.

FIG. 7 is a tabular representation of QoS levels and QoS sums associated with received requests according to some embodiments.

FIG. 8 is a table illustrating request distribution logic according to some embodiments.

FIG. 9 is a tabular representation of requests sorted by QoS levels according to some embodiments.

FIG. 10 is a tabular representation of servers sorted by performance scores according to some embodiments.

FIG. 11 is a tabular representation of QoS levels and QoS sums associated with received requests according to some embodiments.

FIG. 12 is a table illustrating request distribution logic according to some embodiments.

FIG. 13 illustrates a cloud-based architecture according to some embodiments.

### DETAILED DESCRIPTION

The following description is provided to enable any person in the art to make and use the described embodiments. Various modifications, however, will remain readily-apparent to those in the art.

Conventional load balancing algorithms are suitable in the presence of sufficient hardware/software resources but cause bottlenecks in low-resource conditions. In these conditions, conventional algorithms may allow requests of lower-QoS tenants to block requests of a higher-QoS tenant. Consequently, the response time experienced by the higher-QoS tenant may violate the SLA of the tenant.

According to some embodiments, incoming requests are distributed to service instances based on the expected performance of the service instances and on the different QoS levels of different tenants from which the requests are received. Embodiments may therefore address the problem of providing improved performance to high-QoS level tenants as compared to low-QoS tenants in a multi-tenant system.

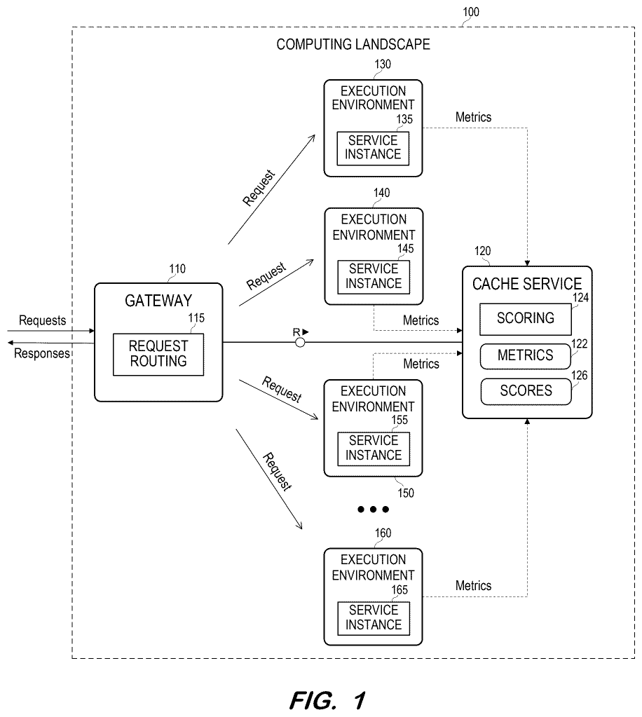

FIG. 1 illustrates computing landscape 100 according to some embodiments. Computing landscape 100 may comprise any number of hardware and software components which may provide functionality to one or more users (not shown). The components of landscape 100 may be on-premise, cloud-based (e.g., in which computing resources are virtualized and allocated elastically), distributed (e.g., with distributed storage and/or compute nodes) and/or deployed in any other suitable manner.

Computing landscape 100 includes gateway 110 for routing incoming requests associated with one or more applications, and for providing authentication, authorization, and load balancing. Gateway 110 includes request routing component 115 which determines an endpoint to which an incoming request should be forwarded. For example, upon receiving an incoming request intended for a given service, request routing component 115 may determine a set of execution environments (e.g., servers) which could potentially respond to the request, and one of the execution environments to which the request should be distributed.

As will be described below, gateway 110 may execute request routing component 115 to determine a QoS level of tenants associated with several received requests, determine performance metrics of each of several execution environments, and distribute each of the N requests to a respective one of the execution environments based on the QoS levels and the performance metrics.

Cache service 120 is accessible to gateway 110 and stores performance metrics 122 associated with each of execution environments 130, 140, 150 and 160. Performance metrics 122 may comprise values of any suitable metrics which may represent the responsiveness of an execution environment. Metrics 122 may include but are not limited to values not limited to CPU utilization percentage, memory utilization percentage, system load and count of processing tasks. Cache service 120 may comprise a key-value in-memory database, such as but not limited to a Redis cluster.

Each of execution environments 130, 140, 150 and 160 may regularly provide its metrics to cache service 120. Each of execution environments 130, 140, 150 and 160 may include its own respective metric monitoring components and provide metric values to cache 120 on a schedule, in response to a trigger, in response to a request from cache service 120 or another component, etc. According to some embodiments, computing landscape 100 includes a separate monitoring component (not shown) for determining metric values associated with execution environments 130, 140, 150 and 160 and for providing those values to cache service 120. For example, execution environments 130, 140, 150 and 160 may expose endpoints (e.g., HTTP endpoints) from which a monitoring component scrapes metrics values.

Cache service 120 may execute scoring component 124 to determine scores 126 based on metrics 122. Scoring component 124 may comprise an algorithm to determine a current value of a performance score 126 for each of execution environments 130, 140, 150 and 160 based on metrics 122 of each execution environment. Request routing component 115 may request scores 126 from cache service 120 and determine how to distribute requests among execution environments 130, 140, 150 and 160 based on the scores (and on the QoS levels of the tenants associated with the requests). In some embodiments, request routing component 115 requests metrics 122 from cache service 120 and determines a score for each execution environment based on metrics 122.

An execution environment may provide an operating system, services, I/O, storage, libraries, frameworks, etc. to services executing therein. Service instances 135, 145, 155 and 165 are different instances of the same multi-tenant service. Service instances 135, 145, 155 and 165 may comprise program code executable by one or more processing units of their respective execution environments to provide functions based on coded logic and data. Those functions may comprise any computing functions that are or become known.

Accordingly, each execution environment 130, 140, 150 and 160 of computing landscape 100 executes a different instance of the same multi-tenant service. Computing landscape 100 may include additional execution environments (not shown) that may execute different services. An execution environment according to some embodiments may comprise one or more physical servers and/or virtual servers executing a monolithic or microservice-based application. According to some embodiments, an execution environment may comprise a container executing in a node of a container orchestration system such as Kubernetes. Some execution environments are capable of executing a plurality of varied services and need not necessarily be limited to executing a single service.

Each of service instances 135, 145, 155 and 165 accesses one or more databases (not shown) during operation. The database(s) may be implemented using one or more storage systems, each of which may be standalone or distributed, on-premise or cloud-based. The database(s) may comprise any type of database, data warehouse, object store, or other storage system that is or becomes known.

The database(s) typically stores metadata which describes the structure and interrelationships (i.e., the schema) of data used by the services. The data may comprise multi-tenant data stored in any format that is or becomes known. The database(s) may be multi-tenant aware, capable of serving requests based on the tenant associated with the request. If the database(s) is not multi-tenant aware, one schema of a single instance may be used for all tenants, where the data of each tenant is partitioned via a discriminating column.

In operation, gateway 110 receives several requests intended for a particular service. As described, the particular service may be independently implemented by each of service instances 135, 145, 155 and 165. The requests may include requests sent directly to gateway 110 by a user or received from other services or applications operated by a user. Each received request is associated with a user and each user is associated with a tenant.

Each tenant may be a party to a distinct subscription/agreement/contract with a provider of landscape 100. Each tenant may therefore be associated with a different QoS level. The level may be determined based on an agreement between the tenant and the provider as is known in the art. Embodiments are not limited to any particular number or gradations of QoS levels. Gateway 110 may store the QoS level associated with each tenant in accessible memory.

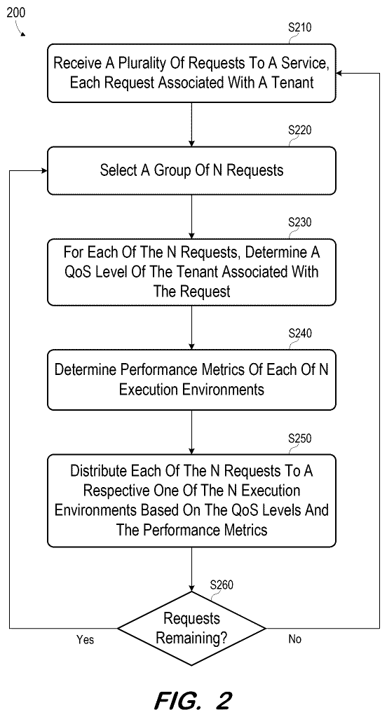

As described above, request routing component 115 may determine an endpoint to which an incoming request should be forwarded. This determination is based on a QoS of the request and performance metrics of candidate endpoints according to some embodiments. FIG. 2 is a flow diagram of process 200 to provide QoS-specific request distribution according to some embodiments.

Process 200 and the other processes described herein may be performed using any suitable combination of hardware and software. Program code embodying these processes may be stored by any non-transitory tangible medium, including a fixed disk, a volatile or non-volatile random-access memory, a DVD-ROM, a Flash drive, a magnetic tape, and solid-state Random-Access Memory (RAM) or Read Only Memory (ROM) storage, and may be executed by any number of processing units, including but not limited to processors, processor cores, and processor threads. Such processors, processor cores, and processor threads may be implemented by a virtual machine provisioned in a cloud-based architecture. Embodiments are not limited to the examples described below.

Initially, at S210, a plurality of requests to a service are received. Each request is associated with a tenant. The service is implemented by a plurality of execution environments, and therefore each of the requests may be sent to any of the execution environments for handling.

In one example of S210, a user operates a client device (e.g., a desktop computer) to execute a Web browser application. The user may select or otherwise input a Uniform Resource Locator (URL) associated with a cloud-based service, causing the Web browser to send a request to a cloud gateway corresponding to the URL. The request may include a security token and the cloud gateway may perform authentication and authorization using the token. For example, the gateway may authenticate the user as belonging to a particular tenant.

According to some embodiments, S210 includes filtering the plurality of requests from a larger set of received requests. For example, the plurality of requests may comprise only those requests which require a significant amount of processing resources and/or processing time. This plurality of requests may be identified using a list of known “complex” requests. Any other requests which are received are distributed to service instances using load balancing algorithms which are different from process 200. Due to such filtering, process 200 may be performed only with respect to those requests for which the benefits of process 200 outweigh the latency and overhead costs of process 200.

A group of N requests is selected from the plurality of requests at S220. The number N may be equal to a number of execution environments which are believed to be available to handle the requests. In some embodiments, N is less than the number of available execution environments but is instead indicative of a number of incoming requests to be distributed in parallel at any one time using the techniques described herein.

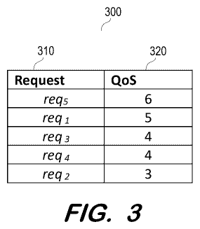

A QoS level is determined for each of the N requests at S230. The QoS level determined for a request is the QoS level of the tenant associated with the request. As mentioned above, a gateway performing process 200 may have access to data indicating a QoS level for each current tenant of a multi-tenant system. FIG. 3 shows tabular representation 300 of QoS levels 320 determined for each of N=5 requests 310 at S230. Embodiments are not limited to the range or granularity of QoS levels shown in FIG. 3. Requests req₃ and req₄ may be associated with the same tenant, or with different tenants which are associated with the same QoS level, i.e., 4.

Performance metrics of each of N execution environments are determined at S240. Each of the N execution environments executes an instance of the service with which the requests are associated. If more than N execution environments are available, S240 also includes selection of N execution environments. The performance metrics may be retrieved directly from each of the execution environments, or from a cache in which each execution environment stores its metrics.

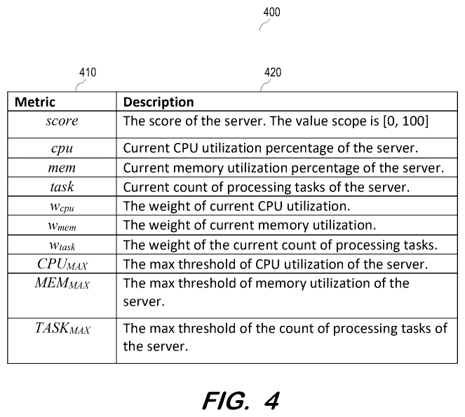

FIG. 4 shows table 400 including descriptions 420 of various performance metrics 410 according to some embodiments. Table 400 includes a metric score which is determined based on retrieved values of the other ones of metrics 410. As mentioned above, the gateway may simply retrieve a value of score for each of the N execution environments at S240, where the value is calculated and stored by a centralized cache such as cache service 120.

The value of score may be determined using any suitable formula. The value of score may be inversely related to cpu, mem, and task. According to some embodiments:

$$score = \{ \begin{matrix}0 , if cpu \geq {CPU}_{MAX} or mem \geq {MEM}_{MAX} or task \geq {TASK}_{MAX} \\ MAX ( 0 , 100 - {w}_{cpu} * cpu - {w}_{mem} * mem - {w}_{task} * task ) , otherwise\end{matrix}$$

In the above formula, the value of score is 0 if the values of any of cpu, mem, and task reach their pre-defined maximum thresholds.

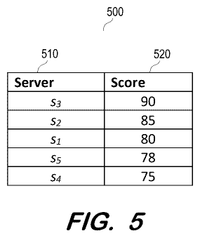

FIG. 5 is a tabular representation 500 of performance scores 520 determined at S240 for N execution environments (i.e., servers) 510 according to the present example. Next, at S250, each of the N requests is distributed to a respective one of the N execution environments based on the QoS levels determined at S230 and the performance metrics determined at S240. According to some embodiments, and to prioritize requests of higher-QoS tenants, S250 includes sorting the N execution environments into a first sorted list in descending order according to their performance scores as shown in FIG. 5 and sorting the N requests into a second sorted list in descending order of QoS as shown in FIG. 3. Next, the first request of the second sorted list is distributed to the first execution environment of the first sorted list, the second request of the second sorted list is distributed to the second execution environment of the first sorted list, . . . , and the Nth request of the second sorted list is distributed to the Nth execution environment of the first sorted list. With respect to the example of FIGS. 3 and 5, req₅>s₃, req₁>s₂, req₃>s₁, req₄>s₅, req₂>s₄.

In some embodiments, execution environments associated with a score of 0 are not considered in S250. This scenario may result in one or more of the lowest-QoS requests of the N requests not being distributed to any execution environment at S250. Such undistributed requests may be returned to the group of requests which were received at S210 but are not yet distributed.

In this regard, flow returns from S260 to S220 if it is determined that any requests received at S210 remain to be distributed. A group of N of these requests is selected at S220 and flow continues as described above to distribute the N requests based on their QoS levels and server performance. If it is determined at S260 that no requests remain, flow returns to S210 to receive a next plurality of requests to the service.

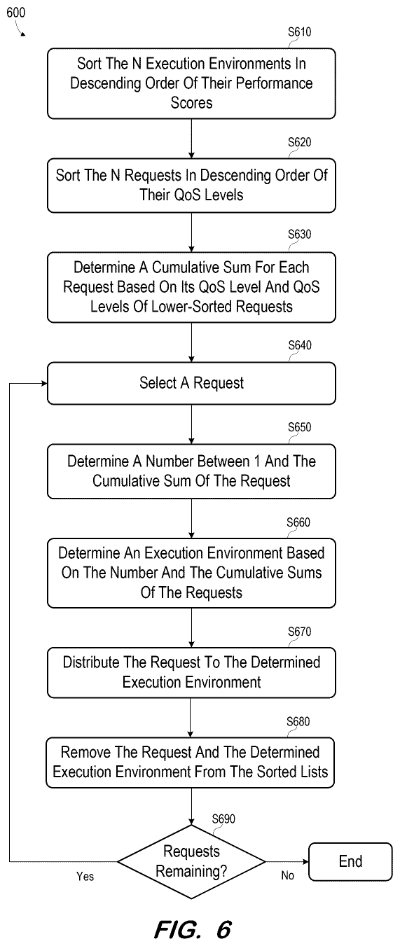

According to some embodiments, process 200 prioritizes the performance provided to tenants associated with higher QoS levels. However, tenants associated with lower QoS levels always receive the poorest available performance. To address these potential shortcomings, FIG. 6 illustrates a flow diagram of a process 600 to manage the distribution of service requests according to some embodiments of S250.

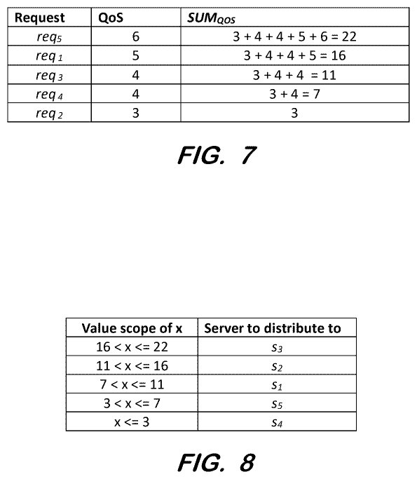

Initially, at S610, the N execution environments are sorted in descending order of their performance scores as described above and illustrated in FIG. 5. Next, at S260, and also as described, the N requests are sorted in descending order of QoS as shown in FIG. 3. At S630, a cumulative sum for each request is determined based on its QoS level and the QoS levels of requests which are lower in the sort order. FIG. 7 illustrates determinations of cumulative sums SUM_{QoS} for each request based on the QoS levels shown in FIG. 3. As shown, the cumulative sum SUM_{QoS} for a request is equal to the sum of the QoS level associated with the request and the QoS level of each request which is lower in the sort order.

One of the N requests is selected at S640 and then, at S650, a number between 1 and the cumulative sum of the selected request is determined. For example, request req₅ may be selected at S640 and, in view of the QoS level of req₅, a number between 1 and 22 is determined at S650. The number may be selected at random such that each number in the range has an equal probability of being selected.

An execution environment is determined based on the number and the cumulative sums of the requests at S660. FIG. 8 depicts data used to determine an execution environment at S660 based on the determined number according to some embodiments. As shown, each row of the sorted execution environments is associated with a number range. The range associated with a given row includes numbers less than or equal to the SUM_{QoS} of the corresponding row of the sorted requests and greater than the SUM_{QoS} of the next row of the sorted requests. The servers of FIG. 8 are also associated with each row in descending order as shown in FIG. 5. S660 comprises determining the range in which the number determined at S650 falls and identifying the execution environment which is associated with the same row as the determined range. For example, if the number determined at S650 is 8, the row including the range “3<x<=7” is identified and corresponding execution environment s₁ is determined at S660.

Due to the calculation of the ranges, there is a 6/22=27.3% probability of determining to distribute the selected request to server s₃, which is associated with the highest QoS level (i.e., 6). The probabilities of determining to distribute the selected request to the remaining servers, in descending order of QoS-level, are s₂=5/22=22.7%, s₁=4/22=18.2%, s₅=4/22=18.2%, s₄=3/22=13.6%.

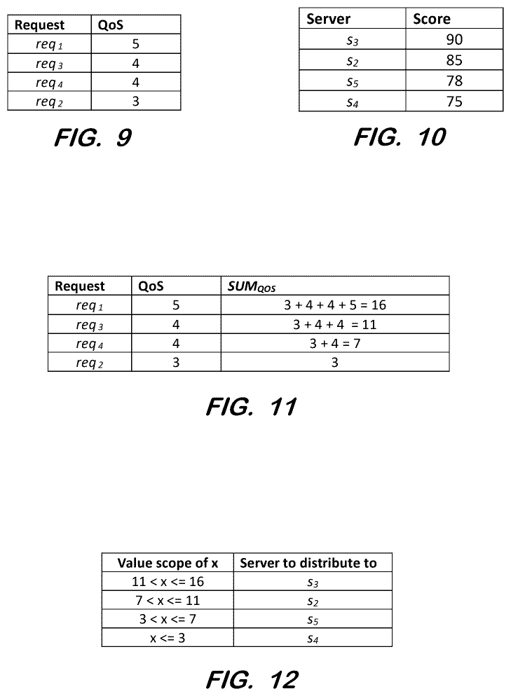

The request (i.e., req₅) is distributed to the determined execution environment (i.e., s₁) at S670. Next, at S680, the distributed request and the determined execution environment are removed from their respective sorted lists. FIGS. 9 and 10 show the sorted lists of the present example after removal of the rows corresponding to request req₅ and execution environment s₁. Since requests remain in the sorted list of FIG. 9, flow returns to S640 from S690.

One of the remaining requests is selected at S640. Next, a number between 1 and the cumulative sum of the selected request is determined at S650. FIG. 11 shows the previously-calculated cumulative sums for each remaining request. It will be assumed that request req₁ is selected at S640 and, due to the SUM_{QoS} level of request req₁ (i.e., 5), a random number between 1 and 16 is determined at S650. An execution environment is determined based on the number and the cumulative sums of the requests at S660. As depicted in FIG. 12, execution environment s₃ is determined if the number is greater than 11 and less than or equal to 16, execution environment s₂ is determined if the number is greater than 7 and less than or equal to 11, execution environment s₅ is determined if the number is greater than 3 and less than or equal to 7, and execution environment s₄ is determined if the number is less than or equal to 3. The probabilities of determining to distribute request req₁ to these servers, in descending order of QoS-level, are s₃=5/16=31.3%, s₂=4/16=25%, s₅=4/16=25%, s₄=3/16=18.8%.

The request (i.e., req₁) is distributed to the determined execution environment at S670, and the distributed request and the determined execution environment are removed from their respective sorted lists at S680. Flow continues in this manner, cycling between S640 and S690, until it is determined at S690 that no more requests remain to be distributed.

Advantageously, process 600 allows for distribution of requests associated with higher QoS levels to servers with high performance scores with high probability and to servers with low performance scores with low probability. Similarly, requests associated with lower QoS levels have a low probability of being distributed to servers with high performance scores and a high probability of being distributed to servers with low performance scores. Embodiments of process 600 not only prioritize the quality of service provided to higher-QoS tenants but also improve the quality of service provided to lower-QoS tenants.

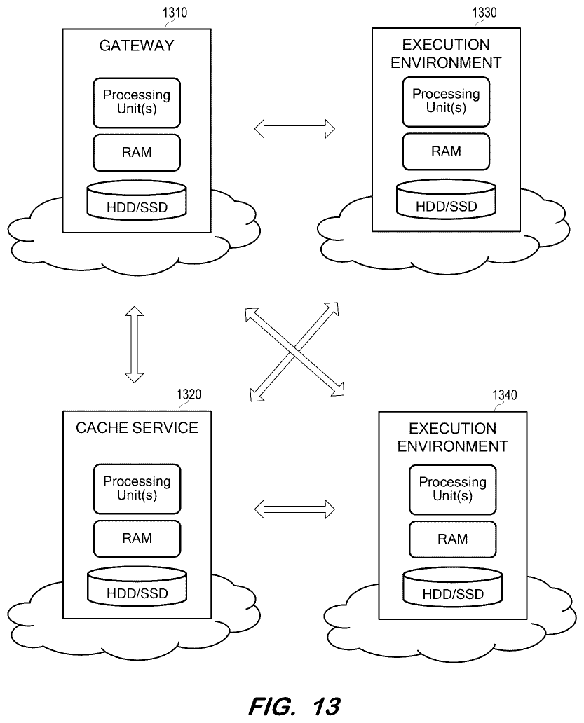

FIG. 13 illustrates a cloud-based database deployment according to some embodiments. The illustrated components may comprise cloud-based compute resources residing in one or more public clouds providing self-service and immediate provisioning, autoscaling, security, compliance and identity management features.

Components 1310-1340 may comprise physical servers or virtual machines supporting containerized applications which provide one or more services to users. Execution environments 1330 and 1340 may execute instances of a service as described herein. Execution environments 1310 and 1320 may execute a gateway and a cache, respectively, as also described herein.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

Embodiments described herein are solely for the purpose of illustration. Those in the art will recognize other embodiments may be practiced with modifications and alterations to that described above.

What is claimed is:

1. A method for distributing requests in a computer system comprising:
receiving a first request to a first service from a first tenant associated with a first quality-of-service (QoS) level;
receiving a second request to the first service from a second tenant associated with a second QoS level;
retrieving a first performance score for a first execution environment;
retrieving a second performance score for a second execution environment;
associating the first request with the first execution environment based on a first relationship between the first QoS level and the first performance score;
associating the second request with the second execution environment based on a second relationship between the second QoS level and the second performance score;
distributing the first request to the first execution environment based on the association of the first request with the first execution environment; and
distributing the second request to the second execution environment based on the association of the second request with the second execution environment.

2. The method of claim 1, wherein associating the first request with the first execution environment based on the first relationship comprises:
calculating a first range of values based on the first QoS level and the second QoS level; and
associating the first execution environment with the first range based on the first performance score.

3. The method of claim 2, wherein calculating the first range comprises:
adding the first QoS level to the second QoS level to determine a first sum;
setting a lower bound of the first range as the second level of QoS; and
setting an upper bound of the first range as the first sum.

4. The method of claim 3, wherein associating the first request with the first execution environment further comprises:
determining a lowest QoS level;
generating a random number between the lowest QoS level and the first sum; and
determining the random number is within the first range.

5. The method of claim 1, wherein associating the first request with the first execution environment based on the first relationship between the first QoS level and the first performance score and associating the second request with the second execution environment based on the second relationship between the second QoS level and the second performance score comprises:
sorting the first request and the second request into a first sorted list according to the first QoS level and the second QoS level;
sorting the first execution environment and the second execution environment into a second sorted list according to the first performance score and the second performance score; and
associating requests of the first sorted list to execution environments located at a corresponding list position of the second sorted list.

6. The method of claim 1, wherein a probability that a request is distributed to an execution environment is directly related to a performance score of the execution environment.

7. The method of claim 1, wherein the first request and the second request are distributed in descending order of QoS level.

8. A system comprising:
a memory storing executable program code; and
one or more processing units to execute the executable program code to cause the system to:
receive a first request to a first service from a first tenant associated with a first quality-of-service (QoS) level;
receive a second request to the first service from a second tenant associated with a second QoS level;
retrieve a first performance score for a first execution environment;
retrieve a second performance score for a second execution environment;
associate the first request with the first execution environment based on a first relationship between the first QoS level and the first performance score;
associate the second request with the second execution environment based on a second relationship between the second QoS level and the second performance score;
distribute the first request to the first execution environment based on the association of the first request with the first execution environment; and
distribute the second request to the second execution environment based on the association of the second request with the second execution environment.

9. The system of claim 8, wherein association of the first request with the first execution environment based on the first relationship comprises:
calculation of a first range of values based on the first QoS level and the second QoS level; and
association of the first execution environment with the first range based on the first performance score.

10. The system of claim 9, wherein calculation of the first range comprises:
addition of the first QoS level to the second QoS level to determine a first sum;
setting of a lower bound of the first range as the second level of QoS; and
setting of an upper bound of the first range as the first sum.

11. The system of claim 10, wherein association of the first request with the first execution environment further comprises:
determination of a lowest QoS level;
generation of a random number between the lowest QoS level and the first sum; and
determination of the random number is within the first range.

12. The system of claim 8, wherein association of the first request with the first execution environment based on the first relationship between the first QoS level and the first performance score and association of the second request with the second execution environment based on the second relationship between the second QoS level and the second performance score comprises:
sorting of the first request and the second request into a first sorted list according to the first QoS level and the second QoS level;
sorting of the first execution environment and the second execution environment into a second sorted list according to the first performance score and the second performance score; and
association of requests of the first sorted list to execution environments located at a corresponding list position of the second sorted list.

13. The system of claim 8, wherein a probability that a request is distributed to an execution environment is directly related to a performance score of the execution environment.

14. The system of claim 8, wherein the first request and the second request are distributed in descending order of QoS level.

15. One or more computer-readable media storing program code executable by a computing system to cause the computing system to perform operations comprising:
receiving a first request to a first service from a first tenant associated with a first quality-of-service (QoS) level;
receiving a second request to the first service from a second tenant associated with a second QoS level;
retrieving a first performance score for a first execution environment;
retrieving a second performance score for a second execution environment;
associating the first request with the first execution environment based on a first relationship between the first QoS level and the first performance score;
associating the second request with the second execution environment based on a second relationship between the second QoS level and the second performance score;
distributing the first request to the first execution environment based on the association of the first request with the first execution environment; and
distributing the second request to the second execution environment based on the association of the second request with the second execution environment.

16. The one or more computer-readable media of claim 15, wherein associating the first request with the first execution environment based on the first relationship comprises:
calculating a first range of values based on the first QoS level and the second QoS level; and
associating the first execution environment with the first range based on the first performance score.

17. The one or more computer-readable media of claim 16, wherein calculating the first range comprises:
adding the first QoS level to the second QoS level to determine a first sum;
setting a lower bound of the first range as the second level of QoS; and
setting an upper bound of the first range as the first sum.

18. The one or more computer-readable media of claim 17, wherein associating the first request with the first execution environment further comprises:
determining a lowest QoS level;
generating a random number between the lowest QoS level and the first sum; and
determining the random number is within the first range.

19. The one or more computer-readable media of claim 15, wherein associating the first request with the first execution environment based on the first relationship between the first QoS level and the first performance score and associating the second request with the second execution environment based on the second relationship between the second QoS level and the second performance score comprises:
sorting the first request and the second request into a first sorted list according to the first QoS level and the second QoS level;
sorting the first execution environment and the second execution environment into a second sorted list according to the first performance score and the second performance score; and
associating requests of the first sorted list to execution environments located at a corresponding list position of the second sorted list.

20. The one or more computer-readable media of claim 15, wherein a probability that a request is distributed to an execution environment is directly related to a performance score of the execution environment.
